(19) United States
(12) Patent Application Publication
(10) Pub. No.: US 2005/0092688 A1
(43) Pub. Date: May 5, 2005

(54) System and process for treating contaminated fluid system

(76) Inventor: Lawrence A. Rabellino, Atascadero, CA (US)

Correspondence Address: PERKINS COIE LLP, P.O. BOX 2168, MENLO PARK, CA, 94026, US

(21) Appl. No.: 10/775,530

(22) Filed: Feb. 9, 2004

Related U.S. Application Data
(60) Provisional application No. 60/517,827, filed on Nov. 5, 2003.

(51) Int. Cl. C02F 1/28; B01D 53/00

(52) U.S. Cl. 210/668

(57) ABSTRACT

A system for treating a fluid stream containing contaminants is described. The system is comprised of a catalyst having a first flow path and a second flow path and an adsorbent bed positioned downstream from the catalyst. A flow diversion member is positioned to direct at least a portion of the fluid stream to or away from said adsorbent bed as the stream exits the catalyst. The stream is passed over said adsorbent bed until a predetermined operating parameter is reached, whereupon the position of the flow diversion member is moved to divert at least a portion of the stream away from the adsorbent bed and into the second flow path of the catalyst. A process for treating an exhaust fluid stream using the system is also described. The system and process find particular use in treating exhaust gas after cold-start, after restart, and during continuous operation of an engine.

This application claims the benefit of U.S. Provisional Application No. 60/517,827, filed November 2003, which is incorporated herein by reference in its entirety.

### FIELD OF THE INVENTION

The present invention relates to a system and a process for treating a stream containing contaminants. More particularly, the invention relates to a process and a system for retaining undesirable components in a stream and converting the undesirable components to more benign compounds.

### BACKGROUND OF THE INVENTION

Fluid streams are generated in an extremely wide range of industries. Often fluid streams are contaminated with components that are undesirable or unacceptable for release into the atmosphere or into water. Undesirable components may also interfere with a downstream process of treatment, hence removal or modification of the component is desired. Such fluid streams can be gas or liquid, and can contain, for example, undesirable hydrocarbons, aromatic hydrocarbons, chlorinated hydrocarbons, fluorinated hydrocarbons, ammonia, nitrogen oxides, sulfur dioxide, hydrogen sulfide, and the like.

A gaseous fluid stream is generated upon combustion of hydrocarbonaceous fuels, such as gasoline and fuel oils. The stream contains undesirable components that include carbon monoxide, hydrocarbons, and nitrogen oxides, that contribute the pollution of the atmosphere and can pose a serious health problem. While exhaust gases from all carbonaceous fuel-burning sources, such as stationary engines, industrial furnaces, etc., contribute to air pollution, the exhaust gases from automotive engines are a principal source of pollution. Thus, automobile emissions of carbon monoxide, hydrocarbons, and nitrogen oxides are subject to regulation and the emission from individual vehicles are subject to compliance with these regulations.

A common method to comply with these regulations and to reduce the amount of pollutants emitted from gasoline-fueled internal combustion engines is to employ a catalyst, and typically a three-way catalyst. The catalyst, once it reaches the appropriate temperature, is effective to cause oxidation of hydrocarbons, oxidation of carbon monoxide, and reduction of nitrogen oxides. Most catalytic converters work optimally at elevated temperatures, generally at or above about 300° C. Typically, the catalyst is heated by contact with the exhaust gas from the engine, so heating the catalyst is dependent on the time required for the exhaust gas to heat. There is, therefore, a time period between when exhaust emissions begin and when the catalyst heats to its light-off temperature. This time period is referred to herein as the “cold-start” period. The catalyst temperature at which about 50% of the emissions from an engine are converted by passage through the catalyst is referred to in the art as the catalyst “light-off” temperature. At temperatures lower than the light-off temperature the catalyst is not able to convert any substantial portion of the exhaust emissions into innocuous compounds, and the exhaust is released to the atmosphere untreated. This is particularly the case during an engine's cold-start period.

One approach to improving conversion of gas emissions during cold-start is to assist the catalyst to reach its light-off temperature more rapidly. This can be achieved by moving the catalytic converter closer to the engine so that hot exhaust gases reach the converter sooner. However, this can reduce the life of the converter by exposing it to extremely high engine exhaust temperatures. Another approach is to preheat the catalytic converter with electric resistance heaters. Selecting a catalyst with a lower light-off temperature, or by adding supplemental or secondary air into the exhaust gas to provide improved oxidation reactions, thereby producing additional exothermic heat (see, for example, WO 01/90541), are other approaches.

The use of an adsorbent bed in combination with a catalyst has been proposed (U.S. Pat. Nos. 5,078,979; 5,051,244; 5,142,864; 5,499,501; US2001/0001648). The adsorbent bed adsorbs the hydrocarbons discharged during cold-start and until a desorption temperature of the bed is reached when the temperature of the exhaust stream reaches the bed desportion temperature. Provided the desorption temperature corresponds to the catalyst light-off temperature, the exhaust stream is then treated by the catalyst.

There remains a need for an efficient method and apparatus for decreasing noxious emissions from engines, particularly during cold-start, but also during continuous operation. More generally, there remains a need for a simple system and process for removing or treating contaminants in a fluid stream.

### SUMMARY OF THE INVENTION

Accordingly, it is an object of the invention to provide a system and process for treating a fluid stream that contains contaminants.

It is a more particular object of the invention to provide a system for exhaust gas treatment during cold-start and during continuous operation of an engine.

It is another particular object of the invention to provide a process for treating exhaust gas emissions, particularly during cold-start, but also during continuous operation of an engine.

Accordingly, in one aspect, the invention includes a process for removing contaminants in a fluid stream. The process comprises flowing the fluid stream in a first flow path over a catalyst to yield a first exit stream, and directing at least a portion of the first exit stream to an adsorbent bed positioned downstream from the catalyst. The first exit stream is directed over the adsorbent bed until a predetermined operating parameter is achieved, whereupon at least a portion of the first exit stream is diverted to bypass the adsorbent bed for flow over the catalyst in a second flow path.

In one embodiment, the first exit stream is diverted by a flow diversion element, such as a valve or moveable flap, positioned between the catalyst and the adsorbent bed.

In another embodiment, diverting of all or a portion of the first stream occurs when a preselected temperature in the adsorbent bed, in the catalyst, or both, is reached.

Directing at least a portion of the first exhaust stream to an adsorbent bed yields a second exit stream, and the process, in another embodiment, further includes controlling the destination of the second exit stream. In an exemplary embodiment, the second exit stream is controlled so that all or a portion of it is diverted to avoid flow over the catalyst in the second flow path.

Directing the first exhaust stream, in another embodiment, continues until catalyst light-off temperature is reached and until desorption of a substantial portion of adsorbed species on the adsorbent bed is achieved.

In another embodiment, directing continues until catalyst light-off temperature is reached, whereupon a first portion of the first exit stream is diverted to bypass the adsorbent bed and a second portion of the first exit stream continues to flow over the adsorbent bed. In one embodiment, the first portion of the first exit stream is a major portion and the second portion of the first exit stream is a minor portion.

In yet another embodiment, directing continues for a predetermined period of time, whereupon a first portion of the first exit stream is diverted to bypass the adsorbent bed and a second portion of the first exit stream continues to flow over the adsorbent bed.

In still another embodiment, directing continues until a predetermined period of time has lapsed or until a predetermined temperature is reached, whereupon a first portion of the first exit stream is diverted to bypass the adsorbent bed and a second portion of the first exit stream continues to flow over the adsorbent bed.

The predetermined temperature can be a selected catalyst temperature or a selected adsorbent bed temperature. The selected catalyst temperature, in one embodiment, is measured at the point where the first exit stream exits the catalyst.

The catalyst, in one embodiment, has a tube and shell structure, and the first flow path is through the tubes.

The first flow path in the catalyst, in various embodiments, is crosscurrent to the second flow path or is countercurrent to the second flow path.

In another embodiment of the process, directing the first exit stream to an adsorbent bed forms a second exit stream that flows over the catalyst in the second flow path. The first flow path can be crosscurrent, co-current, or countercurrent to the second flow path.

In another aspect, the invention includes a treatment system for a fluid stream. The system is comprised of a catalyst having a first flow path and a second flow path, where the catalyst is positioned to receive a fluid stream in the first flow path. An adsorbent bed is positioned downstream from the catalyst and is in fluid communication with the catalyst. A first flow diversion member, such as a valve, is positioned to direct at least a portion of the fluid stream as it exits the catalyst to or away from the adsorbent bed. The fluid stream as it exits the catalyst, i.e., a catalyst exit stream, is passed over the adsorbent bed until a predetermined parameter is reached, whereupon the flow diversion member is positioned to divert at least a portion of the exit stream away from the adsorbent bed and into the second flow path of the catalyst.

In one embodiment, a second flow diversion member is positioned downstream of the adsorbent bed for directing all or a portion of stream after passage over the adsorbent bed to or away from the second flow path of the catalyst.

In another embodiment, the predetermined parameter is selected from a temperature or a time period. In embodiments where the predetermined parameter is a temperature, the temperature can correspond to the temperature in the catalyst or in the adsorbent bed. In other embodiments, the predetermined parameter is alternatively a time period or a temperature.

The catalyst, in one embodiment, has a tube and shell structural configuration, with inner and outer tube surfaces operative for catalytic activity.

The system, in yet another embodiment, further comprises a temperature sensor positioned for monitoring the temperature of the exit stream. In one embodiment, the flow diversion member position is changed in response to a preselected bed temperature sensed by the temperature sensor.

In other embodiments, the position of the flow diversion member is changed upon lapse of a preselected time period or is changed in response to a preselected bed temperature sensed by the temperature sensor.

In another embodiment, the flow diversion member, the temperature sensor, or other system component is formed form a shape memory alloy.

The first flow path in the catalyst can be countercurrent, co-current, or crosscurrent to the second flow path.

The exit stream is, in one embodiment, a gas stream. In another embodiment, the stream is a liquid stream.

These and other objects and features of the invention will be more fully appreciated when the following detailed description of the invention is read in conjunction with the accompanying drawings.

### BRIEF DESCRIPTION OF THE DRAWINGS

FIG. 1A is a schematic diagram of one embodiment of a system for treating a contaminant-containing fluid stream;

FIG. 1B is a schematic diagram of second embodiment of a system for treating a contaminant-containing fluid stream;

FIGS. 2A-2D are schematic diagrams of a system for treating a contaminant-containing fluid stream generated from an engine and show a method of employing the system in accord with various embodiments of the invention;

FIGS. 3A-3B are schematic illustrations of systems for treating exhaust emissions from an engine according to alternative embodiments of the invention; and

FIG. 4 is a theoretical plot showing concentration of contaminants in a stream as a function of time when left treated via a conventional method (solid line) or when treated according to the system described herein (dashed line).

### DETAILED DESCRIPTION OF THE INVENTION

I. Definitions

As used herein, the term “stream” intends a fluid stream that can be a gas stream or a liquid stream.

The term “hydrocarbons” is understood to encompass partially burned and unburned hydrocarbons and volatile organic compounds (VOCs).

“Nitrogen oxides” or “oxides of nitrogen” intend at least NO and N0₂, together referred to as NOx.

II. Description of the System and Method of Use

The present invention relates to a system and a process for treating undesirable components in a stream. The system and process are suitable for use in treating any fluid stream containing components that are desired to be removed or separated for reuse, for subsequent treatment, for disposal, or for subsequent modification or reaction. The fluid stream can be a liquid stream or a gas stream. The system and process are particularly suited for treating a gas stream, for example, in converting hydrocarbons, carbon monoxide, and nitrogen oxides present in an exhaust gas stream to innocuous components suitable for release into the atmosphere. When used for treating a gas stream, the system and process described herein are suitable for use in a variety of emission-producing equipment, both stationary and mobile, including but not limited to boilers, smelters, diesel generators, jet engines, gas turbine engines, automobiles, and trucks. The system and process are particularly suited for use in hydrocarbon-powered, e.g., gasoline-powered, alcohol-powered and mixtures thereof, internal or external combustion engines.

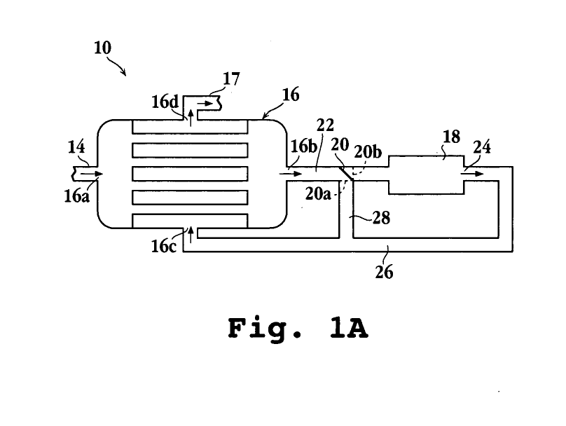

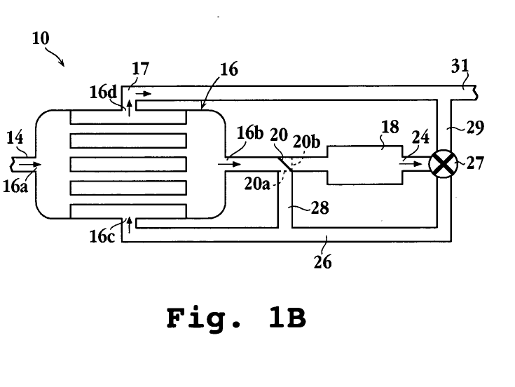

The system and process described below with respect to FIGS. 1-3 are discussed with reference to a gaseous exhaust stream from an engine; however, it will be appreciated that the system and process are equally applicable to liquid streams, and to gas streams generated from any process or equipment.

FIG. 1A shows a first embodiment of a system for treating a contaminant-containing stream. For purposes of illustration, the system of the invention is described for use as an exhaust-emission control system 10 for installation adjacent an engine or, more specifically, adjacent an engine exhaust manifold (not shown). System 10 is capable of being operatively connected to an exhaust line 14 from the engine or its exhaust manifold, by a direct or indirect connection. System 10 includes a catalyst 16 and an adsorbent bed 18 positioned downstream from catalyst 16. A flow diversion member 20 is positioned to direct fluid exiting the catalyst toward or away from the adsorbent bed, in a manner described below.

Catalyst 16 can be any suitable catalytic converter designed for and capable of reducing and/or oxidizing exhaust emissions. When the engine fuel is hydrocarbon based, a three-way catalyst is often used to achieve oxidation of residual hydrocarbons to carbon dioxide and water, oxidation of residual carbon monoxide to carbon dioxide, and reduction of any nitrogen oxides to nitrogen and oxygen. Other fuels, such as alcohols, may not require the reduction capability, and an oxidation catalyst can be used. Three-way catalysts typically consist of a ceramic structure coated with a metal catalyst, usually a noble metal such as platinum, rhodium, ruthenium and palladium, and mixtures thereof. Common catalytic layers include platinum-rhodium (Pt—Rh) type or palladium-rhodium (Pd—Rh) type carried on the surface of porous alumina (Al₂O₃) having a multitude of pores.

The catalyst can be used in particulate form or can be deposited on a solid carrier. The configuration of the carrier can vary from a honeycomb structure to ceramic beads. A catalyst having a shell-and-tube carrier configuration is illustrated in FIG. 1A, however it will be appreciated that other configurations are suitable and many heat exchanger configurations are known in the art, including but not limited to a plate and fin arrangement, two-phase liquids, etc. As will be further discussed below, catalyst 16 has a configuration that permits a first flow path and a second flow path through the catalyst. For the shell-and-tube configuration illustrated in FIG. 1A, a first flow path is defined by fluid entering the “tube” side of the catalyst at point 16a in the direction indicated by the arrow at 16a and exiting the catalyst at the point indicated by the arrow at 16b. The fluid stream exiting the catalyst at point 16b is hereinafter referred to as the “catalyst exit stream.” The second flow path is defined by a fluid stream entering the “shell” side of the catalyst at point 16c in the direction indicated by the arrow at 16c, and exiting the shell side of the catalyst at the point indicated by 16d and in the direction of the arrow. An exit port 17 permits discharge of the fluid stream from the catalyst.

Adsorbent bed 18 can be a conventional or commercially-available adsorbent bed, or can be one designed with more specificity for the present system and method. The bed can be in particulate form or can take the form of a solid monolithic carrier having an adsorbent deposited thereon. Particulate adsorbents can have a variety of shapes, from pellets or granules to rings or spheres. When a monolithic carrier is employed, the adsorbent is typically coated on an inert carrier that provides structural support for the adsorbent. The inert carrier material can be a refractory material, such as a ceramic or a metallic material. Exemplary ceramic materials include cordierite, mullite, zircon, alumina-titante, and the like, foil-shaped metallic materials made of a heat-resistant alloy, such as stainless steel (FeCrAl alloy), and metallic materials molded into a honeycomb structure by powder metallurgy. The carrier material can be formed into any desirable configuration. Configurations having pores or channels extending in the direction of gas flow are common, as are honeycomb configurations. The carrier can also be configured to include cooling fins to facilitate heat loss in order to prolong the time before which the bed reaches its desorption temperature.

The adsorbent component of the adsorbent bed can be comprised of any natural or synthetic material capable of sorption of hydrocarbons and desorption at a desired temperature. The adsorbent is deposited onto the monolithic carrier by any one of a number of methods known in the art, such as slurry coating. Adsorbents are known to those in the art, and include, for example, a zeolite and activated carbon.

The size of the adsorbent bed can vary, but is generally selected so that at least about 30-60%, more preferably greater than 60%, still more preferably greater than 95%, and ideally all measurable, unburned (heavy) hydrocarbons in the engine discharge are adsorbed. It will be appreciated that the size of the bed will depend on the configuration of the carrier, the amount and type of adsorbent, and other factors.

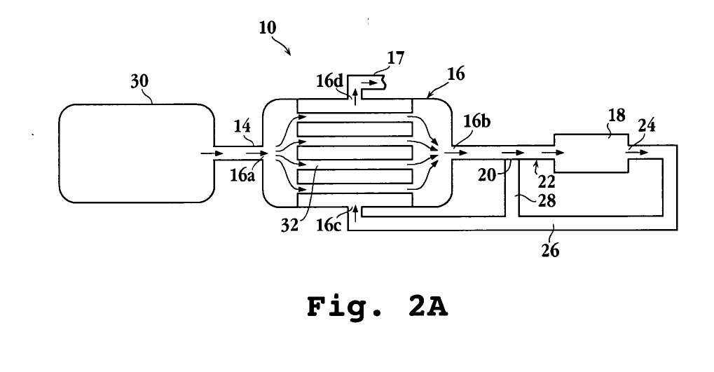

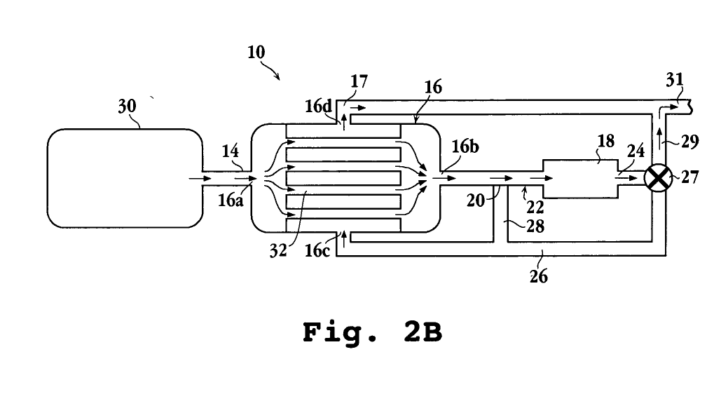

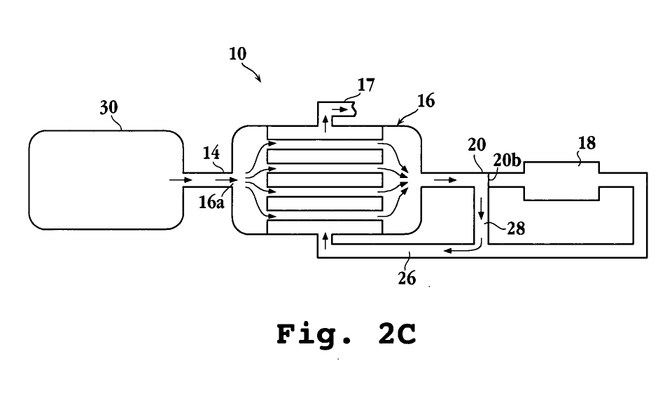

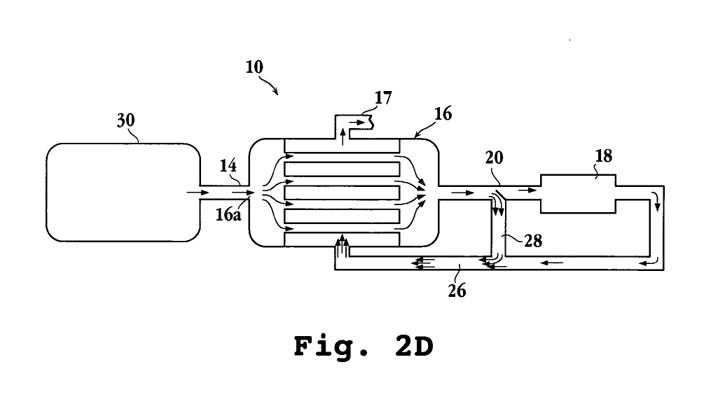

With continuing reference to FIG. 1A, flow diversion member 20 is movable between a first position, shown in phantom at 20a, and a second position, shown in phantom at 20b. In the first position, a fluid stream exiting the catalyst at point 16b is directed through a connecting member 22 toward absorbent bed 18. That is, the absorbent bed, positioned downstream from the catalyst, is in fluid connection with the catalyst via connecting member 22. When the flow diversion member is in its first position, the entire fluid stream exiting the catalyst is directed toward the bed for passage over the bed. Member 20 when moved to the second position indicated in phantom 20b causes the fluid stream exiting the catalyst to be diverted from passage over the adsorbent bed, as will be more fully described with respect to FIGS. 2A-2B below. Member 20 may also be moveable to and fixable in positions between the first and second positions to direct or divert a portion of the fluid stream exiting the catalyst toward or away from the adsorbent bed, as will be described in more detail with respect to FIG. 2C.

When member 20 is positioned to direct the exhaust stream toward the adsorbent bed, the stream passes over the bed for sorption of noxious components and exits the bed via exit port 24. When member 20 is positioned to direct the exhaust stream exiting the catalyst away from the adsorbent bed, e.g., member 20 is in the second position indicated by 20b, the stream enters a bypass line 28 that joins with return line 26 for flow over the second flow path in the catalyst.

The flow diversion member can be any element capable of altering the direction of flow of the fluid stream, in whole or in part, or of interrupting the flow, in whole or in part. Numerous structures are suitable for this function, ranging from a simple flap of material, to simple valves, to more sophisticated valves, such as a valve made of a shape memory metal responsive to a selected system parameter. Shape memory alloys are widely known in the art, examples including nickel-titanium; copper, aluminum, and nickel; copper-zinc and aluminum; and iron, manganese, and silicon. As used herein, the term “valve” will be understood to intend a flow diversion member and to encompass these numerous structures.

Member 20 is preferably responsive to one or more parameters in the system or in the vehicle engine to which the system is connected. For example, member 20 can be electronically controlled by a signal emitted in response to a temperature sensor placed at a desired position; to a preselected time interval; to a sensor measuring the presence or absence of an exhaust stream component; or to another operating parameter. For movement in response to temperature, a sensor can be placed, for example, in the catalyst to measure the catalyst temperature or in the gas stream as it enters or exits the catalyst or the adsorbent bed. When the sensor measures a predetermined temperature, a signal is emitted to reposition member 20 to cause a change in the direction of fluid flow of all or a portion of the stream exiting the catalyst. For movement of the member in response to the presence or absence of an exhaust stream component, a sensor can be placed in a position suitable to determine, for example, the oxygen content in the exhaust stream and to signal movement of member 20 accordingly. Alternatively, the member can be fabricated from a shape memory metal that is intrinsically responsive to a system parameter, such as temperature. It is also possible to design the system so that member 20 changes its position after a certain time interval has lapsed. The position of member 20 can also be altered in response to virtually any factor that affects the vehicle, such as vehicle speed, road gradient, manifold vacuum, altitude, outside ambient temperature, etc. It will also be appreciated that the flow diversion member can be moved in response to one or another of these exemplary parameters through computer controlled “if . . . then” type programming.

FIG. 1B is a schematic diagram of a second embodiment of a system for treating a fluid stream that contains contaminants. The system in FIG. 1B is similar to that of FIG. 1A, hence like elements retain like numerical identifiers for ease of reference. FIG. 1B differs from the system in FIG. 1A by addition of a second flow diversion member, such as valve 27, disposed downstream of the adsorbent bed. It will be appreciated that valve 27 is merely exemplary of a variety of flow diversion members suitable for diversion of the fluid stream, and examples are discussed above. Fluid exiting the adsorbent bed is directed via valve 27 to return fluid line 26 and/or to a bypass line 29. That is, valve 27 is moveable to direct all or a portion of the fluid stream to return line 26 and into the second fluid flow path of catalyst 16. Valve 27 can also be positioned to direct all or a portion of the fluid stream into bypass line 29, which joins with fluid exiting catalyst 16. Like valve 20, valve 27 is responsive to one or more internal or external system parameters for positional control, including but not limited to the factors set forth above.

Turning now to FIGS. 2A-2D, a method of using the system for treating an engine exhaust gas stream will be described. FIGS. 2A and 2C are schematic diagrams showing the system of FIG. 1A, with like elements retaining like numerical identifiers, in use for conversion of noxious materials from an engine exhaust stream. FIG. 2B corresponds to the system of FIG. 1B, with like numerical identifiers for like elements retained for ease of reference. In FIG. 2A, system 10 is in fluid communication via exhaust line 14 with an engine or an engine exhaust manifold 30. Under start-up conditions, the engine exhaust stream flowing from engine 30 is generally at a temperature below the light-off temperature of the catalyst, which, as can be appreciated, varies with catalyst composition, but is typically lower than about 400° C., and generally in a temperature range of 100-300° C. The exhaust stream contains pollutants including a high concentration of unburned hydrocarbons, as well as other combustion by-products such as nitrogen oxides and carbon monoxide. The engine exhaust stream is at this relatively low temperature during the initial period of engine operation, typically for about 30 seconds to several minutes after start-up of a cold engine, depending on ambient conditions, engine and vehicle type, and other conditions.

During this cold-start period, the catalyst is below its light-off temperature and pollutants in a stream flowing over the catalyst are not converted or are minimally converted into more benign products. The exhaust stream enters catalyst 16 at point 16a and flows in and through channels or tubes, exemplified by tube 32, which are coated internally and externally with a catalytic material as described above. As shown in FIG. 2A, valve 20 is positioned to direct the exhaust stream exiting the catalyst at point 16b (e.g., the catalyst exit stream) toward the adsorbent bed for passage over the adsorbent for sorption of the pollutants, particularly the unburned hydrocarbons and NOx. After passage over the adsorbent bed, the stream exits the adsorbent bed cleansed of certain exhaust components, thereby defining a second exhaust stream. This second exhaust stream enters return line 26, which directs the second exhaust stream into the second flow path of the catalyst. The second flow path of the catalyst shown in FIG. 2A begins at point 16c and terminates at point 16d and directs the exhaust stream into the shell side of the shell-and-tube catalyst. The surfaces on the shell side for contact with the second exhaust stream are coated with a catalytic material the same as or different from the catalytic material coating the tube side in the first flow path.

The exhaust stream, and more specifically the catalyst exit stream, flows over the adsorbent bed until a predetermined operating parameter is reached, as discussed above. For example, flow over the adsorbent bed might continue until the temperature of the bed is several degrees below the desorption temperature of the adsorbent. Alternatively, flow over the adsorbent bed might continue until the catalyst has reached its light-off temperature. A bed desorption temperature above the catalyst light-off temperature results in activation of the catalyst while the bed remains operative. Alternatively, flow over the adsorbent bed could continue for a selected period of time determined by, for example, the average amount of time it takes for a given catalyst type to reach its light-off temperature under normal vehicle operating conditions or for the time it takes for the catalyst to exceed its light-off temperature by a certain amount. Alternatively, flow over the adsorbent bed might continue until the amount of carbon monoxide or other exhaust gas component in the stream exiting the catalyst reaches a concentration indicative of catalyst light-off temperature. Alternatively, flow over the adsorbent bed might continue until either a defined temperature is reached or until a certain concentration of a selected exhaust stream component is detected. The skilled artisan will appreciate the numerous possible individual operating parameters and combinations of parameters.

FIG. 2B shows the fluid flow path for the system described with respect to FIG. 1B. Here, valve 20 is positioned to permit fluid flow over adsorbent bed 18. Valve 27 is positioned to direct the second exhaust stream into bypass line 29. This flow path is particularly advantageous during initial start-up of the engine when the fluid stream is cold. Directing the second exhaust stream into bypass line 29 and into the exit 31 avoids flow over the path defined by return line 26 and into the second flow path of the catalyst (point 16c to 16d), thus allowing the catalyst to heat more rapidly. When the catalyst has reached a desired operating temperature, valve 27 is repositioned to direct a portion or all of the fluid stream into return line 26. Alternately, once the catalyst in path 16a-b has heated to a temperature sufficient to catalyze the contaminants but the temperature of the exit stream remains below the desorption temperature of trap 18, valve 20 can divert fluid flow to path 16c in order to fully heat catalyst path 16c-d. In this fashion, path 16c-d will be fully heated and ready to catalyze desorbed contaminants from trap 18. Valve 20 can be partially opened to allow trap 18 to desorb contaminants without removing any substantial heat from path 16c-d, since removal of heat from path 16c-d may reduce the efficiency of the path to catalyze the desorbed impurities from trap 18.

It should be noted that in this system, heat is added, removed and exchanged frequently from element to element for temperature conditioning to support adsorption, desorption, and catalization. Heat exchange devices (fins, sinks, heat pipes, one or two phase fluids, etc.) can be added in multiple locations inside and outside each element to assist in the transfer of heat. This transfer of heat can include using any sources and sinks available to the system depending on the application. In an automobile, these sources and sinks include but are not limited to the vehicle itself, ambient air, ground, etc. Those skilled in the art will understand that the method of transfer of heat is academic to the process, and simple engineering can be used in each embodiment to exploit the most efficient location, source or sink, and method for the transfer of heat.

With continuing reference to FIGS. 2A-2B, once the predetermined parameter is reached, valve 20 is positioned to divert all or a portion of the exhaust gas stream exiting the catalyst away from the adsorbent bed, to bypass flow over the bed. If the system includes a valve downstream of the adsorbent bed, as set forth in FIG. 2B, valve 27 is adjusted to divert fluid flow to the catalyst through path 26 and into port 16c to 16d. Adsorbent bed 18 begins to desorb or release trapped contaminants, such as hydrocarbons, NOx, carbon monoxide, sulfur compounds, etc. Valve 20 can then be adjusted to permit partial flow of the stream over the adsorbent bed to allow gradual release of the contaminants into the fluid stream. The ability to control the rate of flow over the adsorbent bed permits control of the temperature of the adsorbent bed to avoid excessive overheating and to avoid overloading the catalyst with the released contaminants, thus permitting the system to maintain its operating parameters as the adsorbent bed is regenerated. FIG. 2C shows an embodiment where valve 20 is moved to its second position to divert all of the catalyst exit stream away from the adsorbent bed and into bypass member 28. Satisfaction of the predetermined parameter typically correlates, indirectly or directly, with the catalyst reaching or exceeding its light-off temperature. Thus, in one embodiment, valve 20 is moved into a position to divert the catalyst exit stream into the bypass line when a substantial fraction (e.g., greater than about 80%, more preferably greater than about 90%, and most preferably greater than about 95%) of the nitrogen oxides, carbon monoxide, and hydrocarbons are converted into benign compounds by the catalyst. The stream entering the bypass line joins with the return line for entry into the second flow path of the catalyst. As noted above, the second flow path of the catalyst is also lined with a catalytic material and any residual pollutants in the stream are converted during travel through the second flow path prior to exit via port 17.

Valve 20 can remain in its first position until the adsorbent bed is regenerated for future use. That is, full movement of valve 20 to its second position in some embodiments occurs after desorption of the adsorbed pollutants is accomplished, to regenerate the adsorbent bed for future use. Regeneration of the bed via partial movement of valve 20 is also possible as described below with respect to FIG. 2D.

In accord with another embodiment of the invention, when a selected predetermined operating parameter is reached valve 20 is positioned to divert a portion of the exhaust stream exiting the catalyst away from the bed and into the bypass line. The remaining portion of the catalyst exit stream continues to pass over the adsorbent bed. This embodiment is illustrated in FIG. 2D, where valve 20 is positioned to split the catalyst exit stream into two equal or unequal volumetric portions. In the embodiment shown in FIG. 2D, the stream is split into a minor fraction that flows over the adsorbent bed and a major fraction, indicated by double arrows 34, that flows into the bypass line. A major fraction or portion of the stream would typically be a portion that is more than about 50%, the minor portion comprised of the remainder. This valve positioning allows for sufficient exhaust to travel over the bed to desorb and regenerate the bed, with the desorbed components trailed into the return line and mixed with the major fraction that was diverted into the bypass line. Thus, bed regeneration is achieved with the additional benefit of a more controlled desorption so the catalyst is not overwhelmed by a rapid desorption where the desorbed components enter the second flow path of the catalyst at one time.

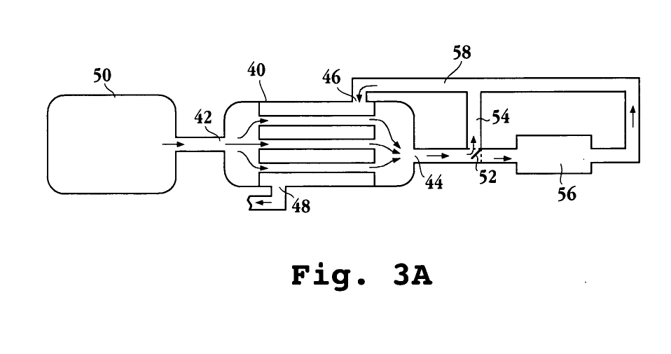

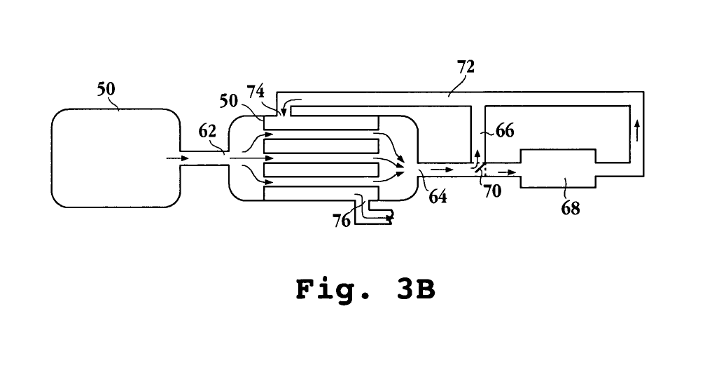

It will be appreciated that the first and second flow paths in the catalyst can vary from the cross-current flow illustrated in FIGS. 1 and 2. FIGS. 3A-3B are schematic diagrams of alternative flow paths where the first and second flow paths in the catalyst are counter-current (FIG. 3A) or co-current (FIG. 3B). As seen in FIG. 3A, catalyst 40 has four ports, 42, 44, 46, 48, for fluid flow into and out of the catalyst. The first flow path is defined by entry of a gas exhaust stream from engine 50 into inlet port 42, travel through the catalyst, and exit of the stream via outlet port 44. The gas exhaust stream at exit port 44 will be referred to as the catalyst exit stream. The position of valve 52 determines whether all or a portion of the catalyst exit stream enters bypass line 54 or flows over adsorbent bed 56. In either case, the stream eventually reaches return line 58 which returns the stream to the catalyst, for flow over the second flow path of the catalyst. The second flow path is defined flow into the catalyst at inlet 46, flow over the catalyst for exit via outlet 48. As seen in the diagram, the second flow path is in a countercurrent direction from the first flow path.

FIG. 3B shows a catalyst 60 configured for co-current flow of the first and second fluid flow paths in the catalyst. The first flow path is similar to that discussed above in FIG. 3A, where fluid enters at inlet port 62 and exits at outlet port 64. All or a portion of the exhaust stream exiting the catalyst at port 64, the catalyst exit stream, enters a bypass line 66 or is directed to an adsorbent bed 68, depending on the position of a valve 70. Upon reaching a return line 72, the stream is directed for a second pass through the catalyst that carries the fluid in a direction co-current with the stream in the first fluid path. Fluid enters the second flow path at inlet port 74, flows over the catalyst, and exits at outlet port 76.

It will be appreciated that selection of the relationship between the flow paths of the first and second fluid flow paths in the catalyst will vary according to various operating factors. That is, a cross-flow (FIGS. 1A-1B ), counter-flow (FIG. 3A), or co-current flow (FIG. 3B) arrangement can be selected to keep the adsorbent bed below its desorption temperature for the longest possible period of time or to minimize heat transfer from the fluid in the first path to fluid in the second path to achieve catalyst light-off rapidly. The relationship between the two fluid flow paths in the catalyst is driven by the desired end result (rapid catalyst light-off; maintain low temperature of adsorbent bed; etc.), the materials forming the catalyst and the adsorbent bed, the length of the fluid flow paths, the position of the diverting valve, which dictates the relative amounts of fluid passing over the bed and/or into the bypass line, and other factors which are readily discernable to those skilled in the art.

In a preferred embodiment, the fluid flow relationship is selected to maintain the adsorbent bed at a temperature below its desorption temperature for the maximum possible time period. During this time period, the catalyst achieves light-off and, preferably, reaches a temperature in excess of its light-off temperature, for maximum catalyst efficiency. When a high catalyst efficiency is reached, as determined by satisfaction of a predetermined parameter such as the temperature of the catalyst exit stream or concentration of a selected component in the catalyst exit stream, the valve is repositioned. The valve can be repositioned to divert all or a portion of the catalyst exit stream away from the adsorbent bed. Preferably, a portion of the stream is diverted away from the bed for entry into the bypass line. The remaining portion, and preferably a minor portion, flows over the bed until the temperature of the minor portion is sufficient to cause desorption of components from the bed. The desorbed pollutants are trailed into the return line, for mixing with the fluid also entering the return line via the bypass line. The pollutants in the fluid stream enter the catalyst for flow over the second fluid flow path and conversion of the pollutants into innocuous compounds.

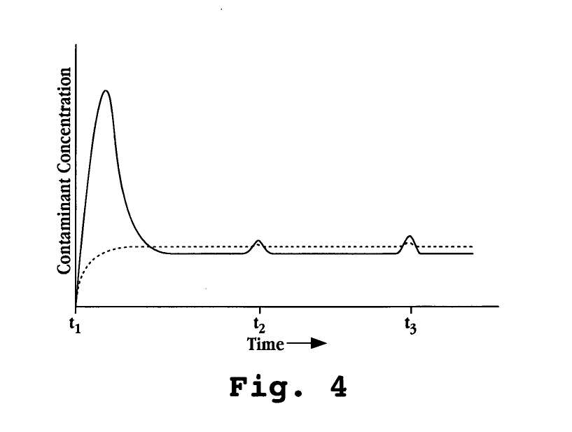

FIG. 4 shows theoretically the concentration of contaminants in a fluid stream as a function of time when left untreated or treated via a conventional method (solid line) or when treated according to the system described herein (dashed line). Time T1 corresponds to engine start-up. The solid line corresponds to a conventional method of exhaust treatment where the system relies on a catalytic converter. At engine start-up, the emission of the exhaust contains a high concentration of contaminants since the catalyst is below its light-off temperature. When the catalyst reaches its operating temperature, the contaminants are removed from the exhaust stream. Time T2 and T3 correspond to periods of restarting the engine, where the system is still warm but an accumulation of contaminants has occurred during the engine off period. These contaminants are released upon restart. The dashed line corresponds to the contaminant concentration for the system described here, where the combined catalyst and adsorbent bed combination effectively remove the majority of the contaminants at start-up (T1) and during restart (T2, T3).

From the foregoing, it can be seen how various objects and features of the invention are met. The system of the invention provides for treatment of a contaminant-containing fluid stream. In particular, the system finds use in treating emissions from an engine during cold start and during restart and continuous operation periods when the exhaust stream is below the catalyst light-off temperature. A catalyst in the system is designed to have two fluid flow paths for conversion of pollutants in the stream to more benign compounds. Exhaust from the engine flows through the catalyst's first fluid flow path and upon exiting the catalyst is initially directed to flow over an adsorbent bed for removal of noxious compounds. Flow of the catalyst exit stream over the adsorbent bed continues, at least in part, until a predetermined operating parameter is reached. The cleansed stream exiting the adsorbent bed is directed back to the catalyst, for flow through a second flow path in the catalyst. The predetermined operating parameter signifies, directly or indirectly, that the catalyst has reached or exceeded its light-off temperature. Satisfaction of the predetermined parameter results in a signal being sent to reposition a valve situated between the catalyst and the adsorbent bed. The valve is repositioned to divert all or a portion of the stream exiting the catalyst after passage therethrough via the first flow path away from the adsorbent bed. The diverted stream is directed into the second flow path of the catalyst prior to discharge into the atmosphere or into a further process.

Although the invention has been described with respect to particular embodiments, it will be apparent to those skilled in the art that various changes and modifications can be made without departing from the invention.

1. A process for removing contaminants in a fluid stream, comprising
flowing the fluid stream in a first flow path over a catalyst to yield a first exit stream;
directing at least a portion of the first exit stream to an adsorbent bed positioned downstream from said catalyst, said directing continuing until a predetermined operating parameter is achieved; and
after said operating parameter is achieved, diverting at least a portion of said first exit stream to bypass said adsorbent bed for flow over said catalyst in a second flow path.

2. The process according to claim 1, wherein said diverting is achieved by a flow diversion member positioned between said catalyst and said adsorbent bed.

3. The process according to claim 2, wherein said diverting occurs when a preselected temperature in the adsorbent bed, in the catalyst, or both is reached.

4. The process according to claim 1, wherein said directing at least a portion of the first exhaust stream to an adsorbent bed yields a second exit stream, and said process further includes controlling the destination of said second exit stream.

5. The process according to claim 4, wherein said controlling comprises controlling the second exit stream so that all or a portion of the second exit stream is diverted to avoid flow over the catalyst in the second flow path.

6. The process according to claim 1, wherein said catalyst has a tube and shell structure, and said first flow path is through said tubes.

7. The process according to claim 1, wherein said directing continues until catalyst light-off temperature is reached and until desorption of a substantial portion of adsorbed species on the adsorbent bed is achieved.

8. The process according to claim 1, wherein said directing continues until catalyst light-off temperature is reached, whereupon a first portion of the first exit stream is diverted to bypass the adsorbent bed and a second portion of the first exit stream continues to flow over said adsorbent bed.

9. The process according to claim 8, wherein the first portion of the first exit stream is a major portion and the second portion of the first exit stream is a minor portion.

10. The process according to claim 1, wherein said directing continues for a predetermined period of time, whereupon a first portion of the first exit stream is diverted to bypass the adsorbent bed and a second portion of the first exit stream continues to flow over said adsorbent bed.

11. The process according to claim 1, wherein said directing continues until a predetermined period of time has lapsed or until a predetermined temperature is reached, whereupon a first portion of the first exit stream is diverted to bypass the adsorbent bed and a second portion of the first exit stream continues to flow over said adsorbent bed.

12. The process according to claim 11, wherein said predetermined temperature is a selected catalyst temperature or a selected adsorbent bed temperature.

13. The process according to claim 12, wherein said selected catalyst temperature is measured at the point where the first exit stream exits the catalyst.

14. The process according to claim 1, wherein first flow path is crosscurrent to said second flow path.

15. The process according to claim 1, wherein first flow path is countercurrent to said second flow path.

16. The process according to claim 1, wherein first flow path is co-current to said second flow path.

17. The process according to claim 1, wherein said directing the first exit stream to an adsorbent bed forms a second exit stream that flows over said catalyst in said second flow path.

18. The process according to claim 17, wherein first flow path is crosscurrent to said second flow path.

19. The process according to claim 17, wherein first flow path is countercurrent to said second flow path.

20. The process according to claim 17, wherein first flow path is co-current to said second flow path.

21. A treatment system for a fluid stream, comprising
a catalyst having a first flow path and a second flow path, said catalyst positioned to receive a fluid stream in said first flow path;
an adsorbent bed positioned downstream from said catalyst and in fluid communication with said catalyst;
a first flow diversion member positioned to direct at least a portion of the fluid stream to or away from said adsorbent bed as the fluid stream exits said catalyst;
wherein the fluid stream is passed over said adsorbent bed until a predetermined parameter is reached, whereupon said flow diversion member is positioned to divert at least a portion of the stream away from said adsorbent bed and into the second flow path of said catalyst.

22. The system of claim 21, further comprising a second flow diversion member positioned downstream of said adsorbent bed for directing all or a portion of stream after passage over said adsorbent bed to or away from the second flow path of said catalyst.

23. The system of claim 21, wherein the predetermined parameter is selected from a temperature or a time period.

24. The system of claim 21, wherein the predetermined parameter is a temperature in the catalyst or in the adsorbent bed.

25. The system of claim 21, wherein the predetermined parameter is alternatively a time period or a temperature.

26. The system of claim 21, wherein said catalyst has a tube and shell structural configuration, with inner and outer tube surfaces operative for catalytic activity.

27. The system of claim 21, further comprising a temperature sensor positioned for monitoring the temperature of the exit stream.

28. The system of claim 27, wherein said valve position is changed in response to a preselected bed temperature sensed by said temperature sensor.

29. The system of claim 21, wherein said valve position is changed upon lapse of a preselected time period.

30. The system of claim 21, wherein said valve position is changed in response to a preselected bed temperature sensed by said temperature sensor.

31. The system of claim 21, wherein said first flow path is countercurrent to said second flow path.

32. The system of claim 21, wherein said first flow path is crosscurrent to said second flow path.

33. The system of claim 21, wherein said first flow path is co-current to said second flow path.

34. The system of claim 21, wherein said exit stream is a gas stream.
